(19) United States
(12) Patent Application Publication
(10) Pub. No.: US 2008/0114676 A1
(43) Pub. Date: May 15, 2008

(54) METHOD FOR PROVIDING A PREPAID DEBIT CARD FOR DEBT RECOVERY

(76) Inventors: David M. Burton, Minnetonka, MN (US); Maria Brick-Simon, Saint Cloud, MN (US); Julie A. Burggraff, Upsala, MN (US); Andrew T. Carlson, Big Lake, MN (US); LeRoy Northam, Big Lake, MN (US); Pranita Shrestha, Saint Cloud, MN (US); Brian Stone, Alpharetta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/014,431

(22) Filed: Jan. 15, 2008

Related U.S. Application Data
(63) Continuation-in-part of application No. 10/706,470, filed on Nov. 12, 2003.

(51) Int. Cl. G06Q 40/00

(52) U.S. Cl. 705/40

(57) ABSTRACT

Prepaid debit card and cash-back bonuses as an incentive tool for debt recovery. Charge-off accounts are obtained from third party credit holders. The customers for these accounts are contacted for enrollment into a prepaid debit card program. The prepaid debit card program is an incentive to get the customers to pay their outstanding balance down. A participating customer earns a prepaid debit card by meeting minimum performance criteria. Other performance based incentives may also be provided.

### CROSS REFERENCE TO RELATED APPLICATIONS

This application is a continuation-in-part of the United States application for patent that was filed on Nov. 12, 2003, having a title of SYSTEM AND METHOD FOR PROVIDING A CREDIT ACCOUNT FOR DEBT RECOVERY and assigned Ser. No. 10/706,470.

### BACKGROUND OF THE INVENTION

1. Field of the Invention

The present invention relates to the field of credit account products and, more specifically, credit account products that provide for the recovery of charged-off debt.

2. Description of Related Art

Non-paying customers are a reality that credit-issuing businesses cannot totally avoid. When a customer stops paying on a credit account with a positive balance, the creditor must decide how to handle the outstanding debt and attempt to recover at least some of the loss that the account balance represents. Initially, a variety of notices are usually used to encourage the customer to begin paying on the account again. However, after a substantial period of non-payment, most credit-issuers will classify the account as charged-off—representing that they have recognized the unlikelihood of collecting on the full debt obligation.

There are a variety of ways to deal with charged-off accounts. Some common approaches include internal or external departments that negotiate settlement or refinancing for the repayment of some or all of the debt, usually on different terms than those originally associated with the account. Another approach is the use of outside collection agencies that purchase the debt at some reduced rate or charge a commission for recovered monies. Unfortunately, many common tactics have limited success rates and frequently damage the customer relationship.

One approach to the recovery of charged-off debts that has the benefit of both increased collections and maintaining the customer relationship is the use of debt recovery credit accounts, such as reaffirmation credit cards. Essentially, debt recovery credit accounts extend a new credit account to the customer conditioned on repayment of some, or all, of the charged-off debt obligation. In the case of reaffirmation credit cards, the customer is reaffirming their debt obligation to the credit issuer in return for a new line of credit.

Prior methods of administering reaffirmation credit cards involve a two record model. The first record is the credit account itself, with an associated balance, credit limit, interest rate, and other features. The second record is a pre-existing debt record. The pre-existing debt record is a holding account that is reduced by customer payments and may or may not have an interest rate or other features. As payments to the reaffirmation credit card are received, they are split between the two accounts according to some formula (50/50, 25/75, or more complicated fixed or percentage formulas that give payment preferences for new charges or pre-existing debt). Interest rates, service charges, minimum payment formulas, and other aspects are usually different for the two records. For example, the credit account may be administered like any standard credit account, while the pre-existing debt record is an interest free account as long as regular payments continue to be made.

In one version of a reaffirmation credit card, the charged-off debt is actually split between the credit account and the pre-existing debt record. For example, if the charged-off debt was $1000, the opening balance of the credit account would be $500 and the opening balance of the pre-existing debt record would be $500. The credit limit for the credit account would be set to the starting balance ($500), making the available balance $0.

In an alternate version of the reaffirmation credit card, the entire charged-off debt is placed in the pre-exiting debt record—for example, providing an opening credit account balance of $0 and an opening pre-existing debt balance of $1000. The credit limit of the credit account is then set to a low value, such as $50, to provide an initial available credit of $50. Increases of the low starting credit limit can then be based upon establishment of a regular payment history or other criteria moving forward.

Either configuration of the reaffirmation credit card requires the administration of two account records. This increases administrative overhead, complicates formulas and transactions, and makes the account more difficult for the customer to understand and effectively administer. In addition, both configurations provide a credit card to the customer at enrollment and make credit available immediately or after the first payment, no matter how small.

Accordingly, there is a need for a debt recovery credit account that is easier to administer and use than the two record approach of prior reaffirmation credit cards. Improved incentives for payment and limits on the credit-issuer's initial exposure to non-payment or new credit liabilities would also be advantageous.

### SUMMARY OF THE INVENTION

The present invention includes systems and methods for providing a prepaid debit card to a customer as a tool and incentive for debt recovery. In general, this embodiment of the invention involves approaching third party credit holders that are on the verge of writing off or moving into debt recovery alternatives for customers with outstanding balances. The customers for these accounts are then contacted in an effort to enroll them into a prepaid debit card program. The prepaid debit card program is an incentive to get the customers to pay their outstanding balance down. A participating customer is able to earn a prepaid debit card by meeting minimum performance criteria. In some embodiments of the invention, the prepaid debit card is feeless, feeless for a period of time, or feeless depending on maintaining minimum performance criteria. In addition, other incentives may also be provided. For instance, upon meeting certain performance criteria, additional debt may be forgiven or the customer may receive cash-back rewards as a non-limiting example. Other incentives may include coupons, retail discounts, or the like.

A recovery credit account is provided for a customer with an existing charged-off debt. Some of the customer's charged-off debt may be forgiven as part of a settlement when the customer enrolls in the recovery credit account, but the opening balance of the recovery credit account will represent the entire debt obligation of the customer going forward (assuming any contingencies in the settlement are met).

With the debit card embodiment of the invention the customer agrees to pay off the settlement amount over a specified period of time. The debit card is issued upon receipt of the first payment from the customer and is provided the debit care at a substantially reduced or no fee for a certain period of time (typically one year). The reduced or no fee benefit is applicable as long as the customer remains in good standing while repaying their settlement obligation. If the customer falls out of good standing, they can continue to use the debit card but standard utilization fees will apply. Some offers within the program will result in the customer receiving a portion of their settlement repayment transferred to the debit card. Upon completing the settlement repayment, the customer can continue to utilize the debit card at the standard utilization fees. Also upon paying the total settlement obligation, the customer receives a program completion credit that reduces the balance of the recovery credit account to $0.

### BRIEF DESCRIPTION OF THE DRAWINGS

FIG. 1 is a block diagram of an example credit account with debt recovery features.

FIG. 2 is a diagram of example transactions illustrating the enrollment, management, and use of a credit account with debt recovery features.

FIG. 3 is a flow diagram of an example method of enrolling customers in a credit account with debt recovery features.

FIG. 4 is a flow diagram of an example method of managing a credit account with debt recovery features.

FIG. 5 is a flow diagram illustrating another approach for addressing the above-identified needs in art by implementing a prepaid debit card program for encouraging debt recovery.

FIG. 6 is a block diagram of an example system for providing a credit account with debt recovery features.

FIG. 7 is a system interaction diagram showing exemplary components of a potential system implementing an embodiment of the present invention.

FIG. 8 is a flow diagram illustrating the operation of an embodiment of the present invention.

### DETAILED DESCRIPTION

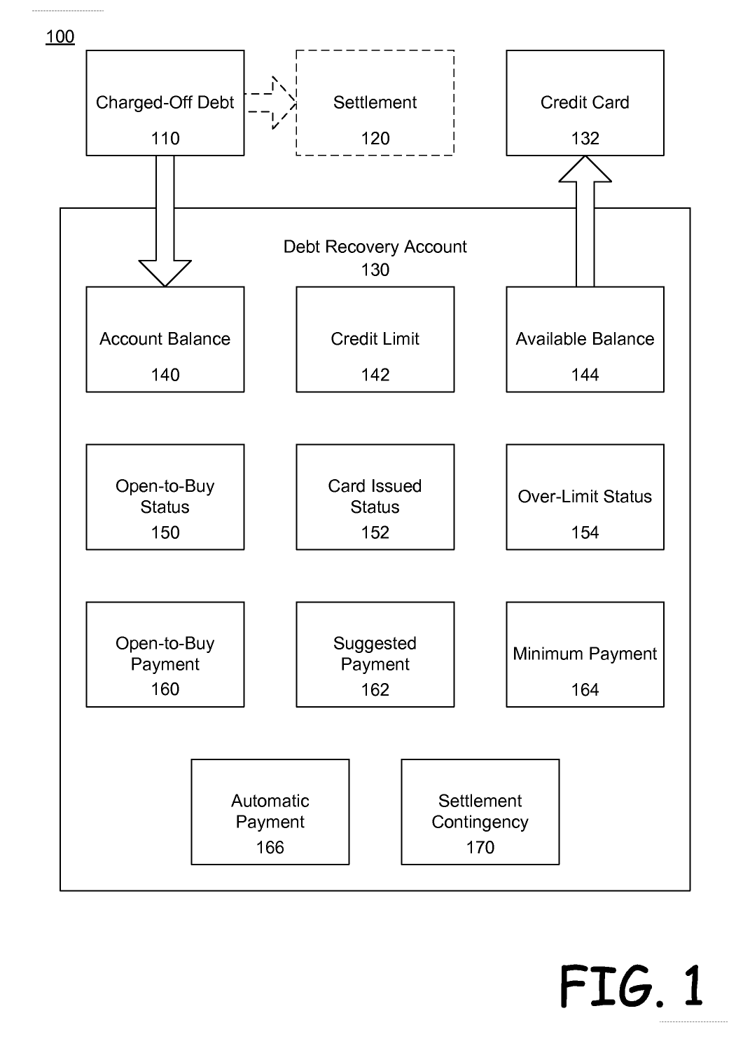

FIG. 1 shows a credit account product 100 for providing debt recovery. A credit issuer that has or acquires a charged-off debt 110 offers the credit account product 100 as a means of realizing at least some portion of the charged-off debt 110. The credit account product 100 is offered to the customer with the charged-off debt 110. The offer may be made as part of a settlement negotiation intended to get the customer to reaffirm at least some portion of the debt. The portion that is not reaffirmed is written-off as a settlement 120. The settlement 120 may be an upfront settlement, may be based upon specified settlement contingencies (such as making future payments), or may be a combination of upfront and contingent settlement. The process of settlement and the possibility of reducing the debt is an incentive for reaffirmation by the customer. Note that the charged-off debt 110 need not represent a single unpaid credit account to a single credit issuer or account holder. For example, the charged-off debt 110 may include debt consolidation from multiple accounts or debt holders that have been aggregated for collection, settlement, or reaffirmation purposes.

The portion of the charged-off debt 110 that is not settled is moved into a new debt recovery account 130. The debt recovery account 130 is a credit account administered by the credit issuing business. In one embodiment, the debt recovery account 130 is a credit card account and is generally administered in accordance with known practices for administering credit card accounts, with the additional features noted below. A credit card 132 is associated with the debt recovery account 130 and issued to the customer to enable access to the debt recovery account 130. While the example embodiment is a credit card account and associated magnetic strip card or smart card token, other forms of credit account may also embody the invention. For example, some credit accounts may be entirely electronic and use a PIN, encryption key, or similar token for access to available credit. Still others may use wands, embedded tokens (e.g., in handheld computers, mobile telephones, watches, wearable computers, etc.), or other credit tokens that enable account access. The debt recovery account 130 includes an account balance 140, a credit limit 142, and an available credit balance 144. The opening account balance is equal to the charged-off debt 110 minus any settlement 120. The opening credit limit is set by the credit issuing business. The available credit balance 144 is equal to the credit limit 142 minus the account balance 140. If the account balance 140 is greater than the credit limit 142, then the available credit balance is $0.

In one embodiment of the credit account product 100, the opening credit limit is set such that it is less than the opening account balance. Establishing a credit limit 142 less than the account balance 140 means that when the debt recovery account 130 is opened it is not open-to-buy. While the debt recovery account 130 is not open-to-buy, the available credit balance 144 is $0 and the customer may not charge against the debt recovery account 130. This arrangement lowers the risk to the credit issuing business and requires that customer make one or more good faith payments to lower the account balance 140 until it is below the credit limit 142 to be able to charge against the account. The debt recovery account 130 includes an open-to-buy status 150 to track whether or not the open-to-buy conditions have been met. The open-to-buy conditions may simply be that the account balance 140 is reduced below the credit limit 142 and the available credit balance 144 is a positive amount. However, in alternate embodiments, the conditions may require that the account balance 140 be reduced below the credit limit 142 by a predetermined margin or that other payment history or assurance provisions are met before open-to-buy status is attained.

The credit issuing business administering the debt recovery account 130 may choose not to issue the credit card 132 for accessing the debt recovery account 130 until open-to-buy status is achieved. In order to track whether or not the credit card 132 has been issued, the debt recovery account 130 includes a card issued status 152. Not issuing the credit card 132 until open-to-buy status is achieved provides the customer with an incentive to pay down the account balance 140 and provides a tangible reward for reaching the open-to-buy milestone.

As with most conventional credit card accounts, the credit issuing business administering the debt recovery account 130 will issue bills to the customer to provide notice of account balance, credit limit, available credit, payment due (or confirmation of scheduled automatic payments), and similar information. The bills may be issued as conventional paper or through a variety of electronic channels, such as electronic mail, web publishing, or push technology to a mobile device, telephone, or other communication device. The credit issuing business may include an open-to-buy payment 160 in the billing information. The open-to-buy payment 160 is the amount required to reduce the account balance 140 to meet the open-to-buy conditions—for example, reducing the account balance 140 below the credit limit 142. The open-to-buy payment 160 provides a reminder of the importance of achieving open-to-buy status and plays a role in motivating the customer to make payments. The debt recovery account 130 may include a suggested payment 162, in addition to the open-to-buy payment 160. The suggested payment 162 provides a recommended payment to achieve open-to-buy status within a predetermined period, such as 12 months from the opening of the account. In one embodiment, the suggested payment is the open-to-buy payment divided by the number of billing cycles remaining in the predetermined period. This provides an incremental approach to reaching open-to-buy status and may be less daunting to the customer than the lump open-to-buy payment. Like conventional credit accounts, the debt recovery account 130 may include a minimum payment 164 based upon the outstanding balance and may be required to avoid penalties or loss of open-to-buy status. As with other credit accounts, automatic payment 166 may be established for the debt recovery account. This may be particularly advantageous in the context of debt recovery, as it avoids some of the causes of non-payment, such as forgetfulness, and gets the customer in the habit of regular payments.

The debt recovery account 130 may include a settlement contingency 170 related to all or part of the settlement 120. The settlement contingency 170 includes conditions that must be met for the account for the customer to comply with the terms of the settlement 120. Conditions may include making the minimum payments for a fixed period, achieving open-to-buy status within a fixed period (such as the predetermined period of the suggested payment), or similar conditions that show progress and commitment to paying off the reaffirmed portion of the debt.

As discussed above, the debt recovery account 130 is administered largely like conventional credit accounts and many existing systems and methods for administering such accounts are adaptable to this purpose. A variety of well-known features of credit accounts have been omitted from FIG. 1 in the interest of brevity, such as interest rate, fees, terms, transaction history, account information (account number, customer information, billing information, PIN, security interest, etc.), and similar credit account features. Such features are well-known and can be assembled in a variety of combinations. Discussion of the myriad possibilities is unnecessary to understanding the embodiments of the present invention.

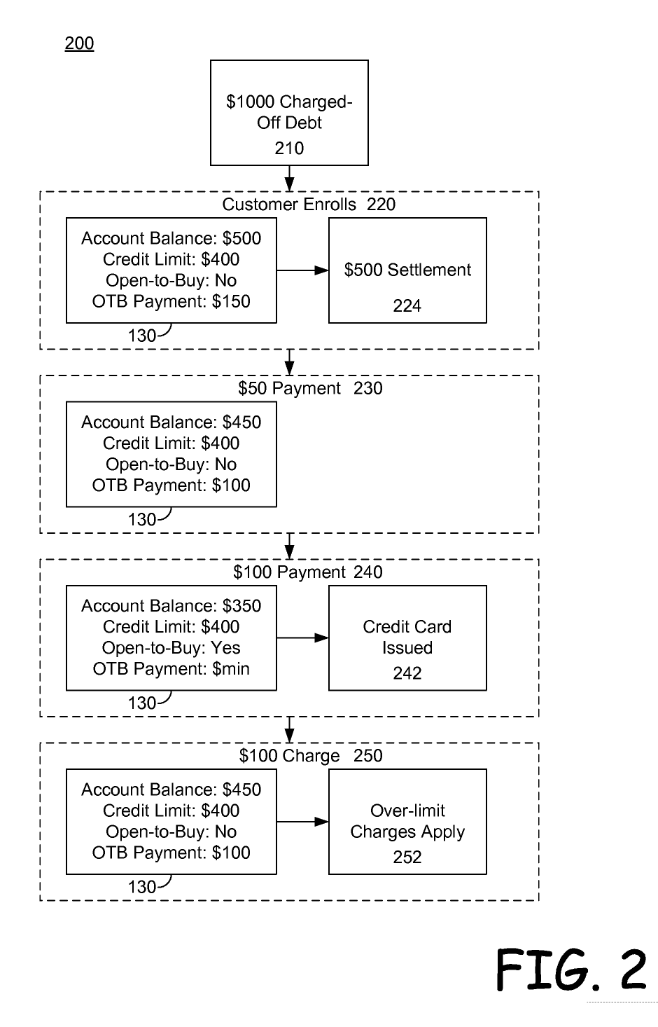

FIG. 2 shows an example series of transactions 200 to demonstrate the operation of the credit account product 100 of FIG. 1. Within the example transactions 200, interest rates and fees have been omitted for simplicity of presentation. However, assessment of monthly interest charges and fees may impact the monthly account balance depending on the terms of the particular credit account. The transactions 200 start with a charged-off debt 210 of $1000 associated with a customer.

The customer enrolls 220 with the credit account product 100. Upon enrolling, the customer negotiates a 50% settlement 224 of her charged-off debt 210. $500 is written-off in the settlement 224. A debt recovery account 130 is created in the customers name and the remaining portion of the charged-off debt 210 is moved into debt recovery account 130. A $500 debt is transferred into the debt recovery account 130 to create an opening account balance of $500. The credit limit of the debt recovery account is $400, less than the opening account balance. The initial open-to-buy status is “no” due to the account balance exceeding the credit limit. In this example, the open-to-buy conditions include that the account balance must be reduced to $50 below the credit limit before the open-to-buy status will change. Thus, the open-to-buy payment is calculated to be $150. Note that no over-limit fee would be assessed, in spite of the fact that the current balance is over the credit limit.

The customer makes a $50 payment 230 to the debt recovery account 130. For example, the payment may have been made in response to a monthly billing cycle and suggested payment value. The entire $50 payment is applied against the $500 account balance, reducing it to $450. The credit limit has not changed and the open-to-buy conditions have not been met. The open-to-buy status does not change. The open-to-buy payment is recalculated based upon the new account balance to be $100. Once again, no over-limit fee would be assessed in spite of the current balance exceeding the credit limit.

The customer makes a $100 payment 240 to the debt recovery account 130. For example, the payment may have been made in response to a second monthly bill and the customer deciding to make the open-to-buy payment on the bill. The account balance is reduced to $350 and the open-to-buy conditions are met (the account balance is $50 less than the credit limit of $400). The open-to-buy status is changed to “yes”. The open-to-buy payment is now the minimum payment required according to the terms of the credit account. As long as the minimum payment is met, the credit account remains open-to-buy. In an alternate example (not shown), the open-to-buy payment is no longer tracked or provided on the bill at all and does not reappear until open-to-buy status is lost, such as by overcharging the account. Because open-to-buy status has been achieved, a credit card is issued 242 to the customer to provide access to the debt recovery account. In addition, over-limit charges will apply to any future charges that carry the account balance over the credit limit.

The customer makes a $100 charge 250 to the debt recovery account 130. For example, the customer makes a purchase using the credit card she recently received. The account balance is increased to $450, which exceeds the current credit limit of $400. Open-to-buy status reverts to “no” to prevent further abuse of the account. A new open-to-buy payment is generated based upon the new account balance. In addition, any over-limit charges in the terms of the account would now apply 252.

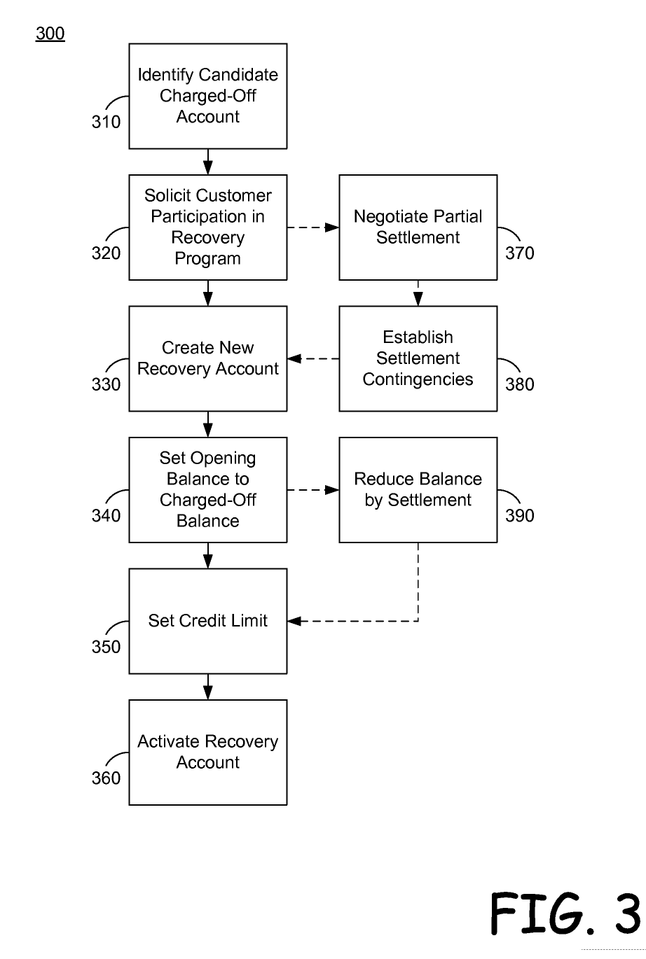

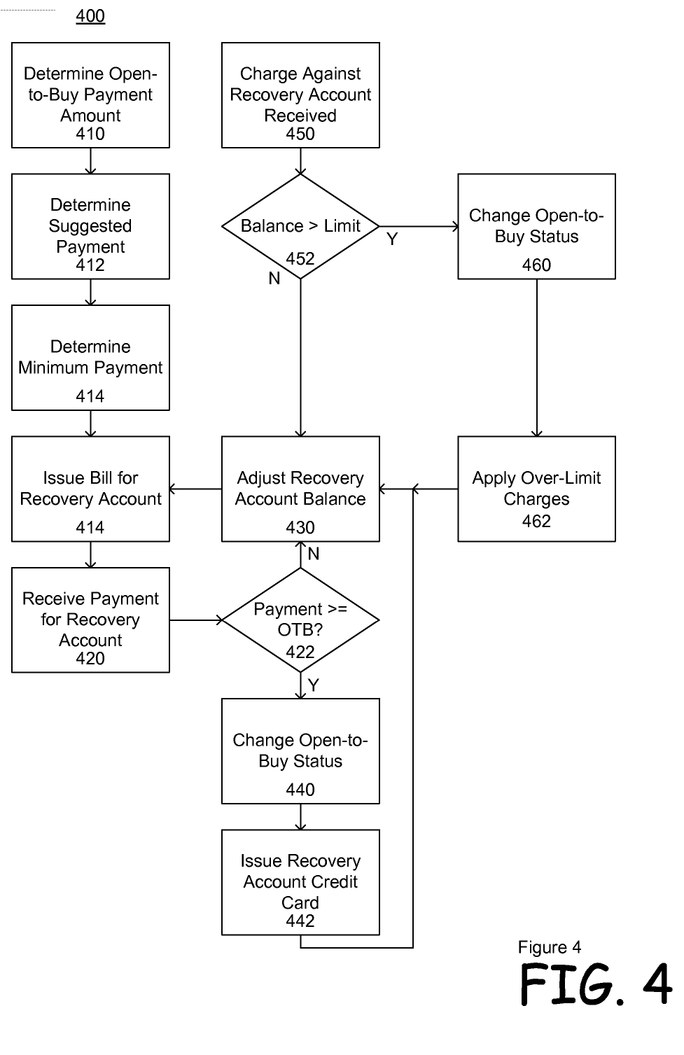

FIGS. 3 and 4 show methods for providing the debt recovery account 130. FIG. 3 shows a method 300 of enrolling customers in the debt recovery account 130 and FIG. 4 shows a method 400 of managing it. Candidate charged-off accounts are identified 310. For example, an administrator evaluates a plurality of charged-off accounts according to a predetermined set of criteria to determine which are likely candidates for reaffirmation and enrollment in the debt recovery account program. Customers associated with the selected charged-off accounts are solicited 320 for participation the debt recovery account program. For example, a program of direct mail and telephone solicitations is employed to contact the customers and present the debt recovery account program to them. For customers that decide to enroll in the program, a new recovery account is created 330. For example, the customer's personal information is associated with a new account number or the new account is associated with an existing customer profile and suite of accounts. The opening balance of the debt recovery account is set 340 to the customer's charged-off debt balance. For example, if the customer's charged-off debt balance was $1000, the opening balance of the debt recovery account would be $1000. The credit limit of the debt recovery account is set 350. For example, the credit limit of the debt recovery account may be determined by a formula based upon the opening balance, such as 50% of opening balance ($500). The debt recovery account is activated 360 to begin management activities. For example, the debt recovery account will enter regular billing cycles, enable receipt of payment, and allow the customer to establish automatic payments, make account balance inquiries, and otherwise manage their account. Note that activation of the account is distinct from achieving open-to-buy status, which is conditioned on the account balance being lower than the credit limit (or other open-to-buy conditions).

In one embodiment of the method 300, a portion of the charged-off debt is settled during the enrollment process. A partial settlement of the charged-off debt is negotiated 370 with the customer. For example, the customer may be offered a 50% settlement as an enticement to reaffirm the debt and enroll in the program. The terms of the settlement may include future conditions to be met by the customer with regard to some or all of the settlement value. Any settlement contingencies are established 380 for the account. If a settlement is negotiated, the opening balance of the debt recovery account is reduced 390 by the settlement amount.

The method 400 provides for managing the debt recovery account. Management of the debt recovery account typically occurs according to a regular billing cycle (e.g. monthly). It includes billing activities, payment receipt activities, and charge receipt activities. The management of the debt recovery account may also include account information management, customer service, non-payment activities, reporting activities, and other management activities. Systems and methods for these myriad processes are well known for credit account management and have been omitted from this description for clarity and brevity.

For each billing cycle, an open-to-buy payment amount is determined 410. For example, the open-to-buy payment amount is calculated based upon the difference between the current account balance and the credit limit, potentially with some margin condition for initiating open-to-buy status. A suggested payment is determined 412. For example, the suggested payment is based upon a recommended period from the opening of the account. The suggested payment is calculated by dividing the open-to-buy payment by the number of billing cycles remaining in the recommended period. A minimum payment is determined 414. For example, the minimum payment may be 3% of the current outstanding balance. A bill is issued 416 to the customer for the debt recovery account. For example, a paper or electronic bill including the current balance, credit limit, available credit (if any), open-to-buy payment, suggested payment, and minimum payment is sent to the customer.

In response to the bill or billing cycle, a payment is received 420 for the debt recovery account. For example, a check or automated payment is received from the customer to reduce the account balance. The payment is evaluated 422 to determine whether it is more than or equal to the open-to-buy payment. If the payment is less than the open-to-buy payment, the debt recovery account balance is adjusted 430 to reflect the received payment and management of the account continues into the next billing cycle. Note that, even if the account balance is still over the credit limit, no over-limit charges will apply until open-to-buy status is achieved for the account at least once. However, if the payment is more than or equal to the open-to-buy payment, several actions occur. The open-to-buy status is changed 440 such that the credit account may now be used for purchases. In addition, a debt recovery account credit card (or other credit access token) is issued 442 to the customer to facilitate access to the credit. Once the open-to-buy status had been changed 440 and the credit card issued 442, the debt recovery account balance is adjusted 430 and management of the account continues into the next billing cycle.

Once the debt recovery account is open to buy, new charges against the account will be received 450. For example, the customer may use his newly received credit card to make a purchase through the appropriate credit card network and associated vendor. The charge is evaluated 452 to determine whether or not the new balance of the debt recovery account will be greater than the credit limit. If not, the balance is adjusted 430 based upon the charge and management of the account continues into the next billing cycle (or receipt of additional charges). If so, the open-to-buy status is changed 460 to prevent additional charges against the account. Over-the-limit charges are now applied 462, because the account balance had been below the credit limit and open-to-buy status had previously been achieved. Management of the account continues into the next billing cycle and may involve additional consequences coming from exceeding the account credit limit, depending on the terms of the account.

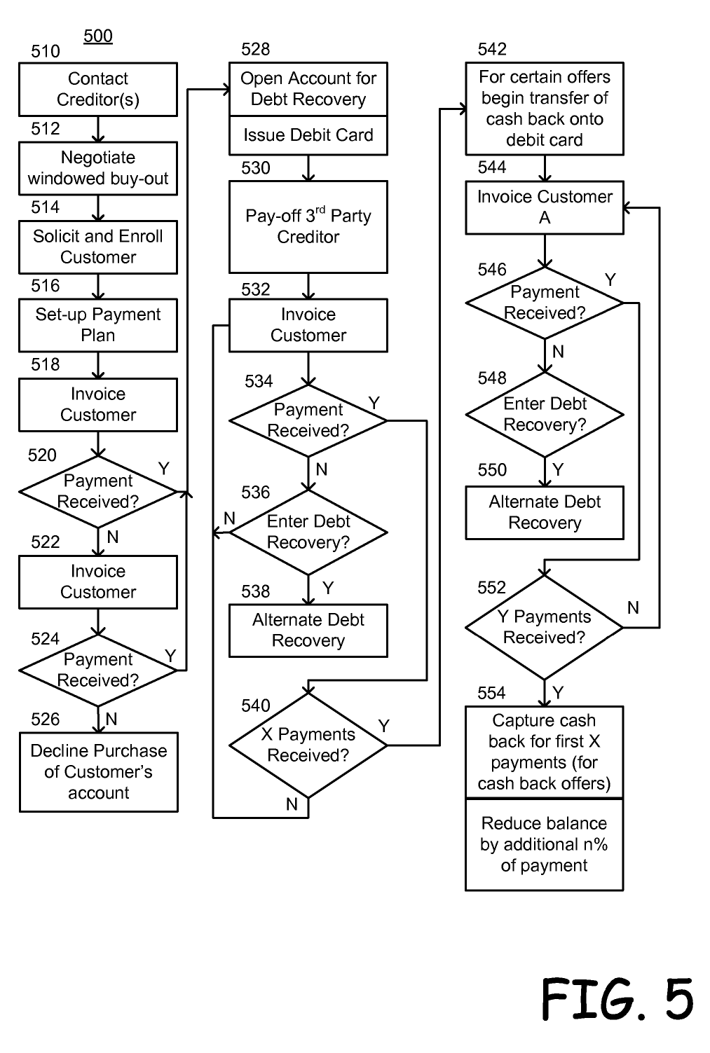

FIG. 5 is a flow diagram illustrating another approach for addressing the above-identified needs in art by implementing a prepaid debit card program for encouraging debt recovery. In general, this embodiment of the invention involves approaching third party credit holders that are on the verge of writing off or moving into debt recovery alternatives for customers with outstanding balances. The customers for these accounts are then contacted in an effort to enroll them into a prepaid debit card program. The prepaid debit card program is an incentive to get the customers to pay their outstanding balance down. A participating customer is able to earn a prepaid debit card by meeting minimum performance criteria. In some embodiments of the invention, the prepaid debit card is feeless, feeless for a period of time, or feeless depending on maintaining minimum performance criteria. In addition, other incentives may also be provided. For instance, upon meeting certain performance criteria, additional debt may be forgiven or the customer may receive cash-back rewards as a non-limiting example. Other incentives may include coupons, retail discounts, or the like.

Specific details of one embodiment of the present invention 500 are further provided with the description of the steps presented in FIG. 5. Initially, during an establishment phase, one or more creditors are contacted or interacted with to identify potential candidates 510. The interaction may take place as a human to human interface but, can also be automated through computer programming to access creditor information and present offers. For instance, in one embodiment of the invention, a relationship may exist between the one or more creditors and the prepaid debit card provider and as such, the provider may have integral access to information from the creditor regarding account balances, credit history, status, etc.

Once potential and/or qualifying candidates or accounts are identified, a buy-out of the bad debt can be negotiated 512. In one embodiment of the invention, this is a windowed buy-out which enables the provider to obtain an option on the purchase of the account if the provider is able to acquire the debtor as a customer. In other embodiments of the invention, the buy-out may need to take place immediately.

Once the buy-out is negotiated, or in some embodiments completed, the provider begins to contact the customers included with the negotiated/purchased accounts in an effort to sign them up for the prepaid debit card program 514. The solicitation can be accomplished in a variety of manners including telephone calls, emails and regular mailings as non-limiting examples. Exhibit A and Exhibit B are examples of solicitations that could be provided in two embodiments of the present invention. The embodiment illustrated in Exhibit A provides a cash back feature whereas the embodiment in Exhibit B does not.

Once a customer has agreed to participate in the plan, further information is gathered from the customer and a final pass/fail analysis may be conducted to determine if the customer qualifies for the program. If the customer qualifies for the program and is still willing to participate, a payment plan for the outstanding debt is established, along with one or more performance threshold requirements 516. The balance to be paid by the customer can be the full outstanding debt or, may be discounted by the provider. In either case, minimum payments are established and a payment schedule is determined.

The customer is then invoiced 518 for the first payment. If a payment is received from the customer 520, the establishment phase is exited and an interim phase is entered. Otherwise, the customer is invoiced again 522. If payment is received after the second invoice 524, again the interim phase is entered. Otherwise, the option to purchase the customer's account is not exercised and the creditor resumes responsibility for the debt 526. In an embodiment in which the accounts are purchased without obtaining an option, the provider may simply move the account into an alternate debt recovery program.

In general, entrance into the interim phase includes a buy-out of the debt from the creditor (in the applicable embodiment) and the issuance of the prepaid debit card to the customer. Further, the interim phase is used to establish further confidence in the customer prior to providing further financial incentives. Thus, upon reception of the payment from the customer, an account is opened for that customer and a debit card may be issued 528. In an exemplary embodiment, the entire amount of the debt is rolled into the new account—even if the provider obtained a discount on the debt. In other embodiments, the provider may instantly pass some or all of the discount to the customer. In addition, upon receipt of the first payment from the customer, the debit card is issued. At this point the creditor is also paid off by the provider 530 or by a third party that through which the provider utilizes for the provisioning of the customer account. For instance, in one embodiment of the invention a company similar to NETSPEND may be used for this service.

In the interim phase, the provider continues to invoice the customer 532. During the phase, the customer load cash onto the prepaid debit card and use the card to make purchases (within the confines of the loaded value). Prepaid debit cards provide the advantage that the user does not have to worry about paying interest, tracking credit card bills, etc. The debit card offers the freedom and control of using cash with the convenience of paying with plastic.

In one embodiment of the invention, the prepaid debit card is issued to the customer under a program that does not charge any annual fees, free loading of the card if performed using direct deposit, a threshold number of free ATM transactions for a given period of time (i.e., one per month), and name brand affiliation, such as MASTERCARD, which enables use of the card anywhere that MASTERCARD debit cards are accepted. Other features may include reduced fees for loading outside of direct deposit, a threshold number of free loads per month, or other features.

If the customer continues to maintain current on the account by making timely payments 534, the debit card remains active. However, if the customer misses a payment or does not meet other performance criteria thresholds, the use of the debit card can be prohibited until the customer brings the account current. Thus, in one embodiment, if the customer misses a payment, the debit card can be disabled but the account can remain active—invoicing the customer 532 and waiting for payment. However, in other embodiments, upon missing payment (or upon missing more than one payment), an alternate debt recovery program may be invoked 538.

In the cash back embodiment associated with the program offering illustrated in Exhibit A, when a customer makes a payment in the interim phase, the number of payments made is tracked. Once the customer has made a threshold number of payments 540, the interim phase is exited and a program phase is entered. Otherwise, the cycle of invoicing the customer and waiting for payment is continued.

In the program phase, the customer begins to receive cash back awards based on his or her payment performance. For instance, in one embodiment of the invention, after the customer makes three payments, a percentage of the remaining payments is provided back to the customer as an incentive to continue making payments and as such, for these instances cash-back transfers are commenced to the customer's debit card 542. In one embodiment, the customer's recovery credit account is reduced by the full 100% of the payment. As an additional incentive to continue to pay, percentage of the payment (i.e., 10%) is given to the customer by being added as a pre-payment on the debit card.

In the program phase, the customer continues to be invoiced 544 and payment activity is monitored 546. In one embodiment of the invention, upon the reception of each payment, the payment history of the customer is analyzed. If the customer has made a threshold number of payments 552, then a percentage of the first few payments made by the customer is recaptured and provided to the customer on the debit card as a reward for successfully completing the repayment obligations 554. Otherwise, if a payment is missed 546, then the provider determines how to proceed 548. The provider may drop back into the interim phase until the account is brought current. Further if two payments are missed the provider may enter an alternate debt recovery program and the reduced fee/free fee benefit of the debit card is rescinded. In another embodiment, missing even one payment may invoke the alternate debt recovery program 550.

Table 1 provides a particular, non-limiting example of one embodiment of the present invention. In the illustrated embodiment, a starting balance of $1100 is inherited from the creditor. The settlement repayment component for the customer in this program is $600 and is set up over a twelve month period with equal payments of $50 per month. The program completion reward credit of $500 will be applied after the customer meets the repayment obligation. Upon reception of the first payment, the establishment phase is exited and the interim phase is entered. In addition, the prepaid debit card is issued and activated. However, at this point no cash awards are provided to the customer. The current balance then drops to $550.

Upon reception of the second payment, the interim phase is maintained and the debit card remains active. The account balance drops to $500 after the second payment. Upon reception of the third payment, the interim phase is maintained, the debit card remains active and the account balance drops to $450. The forth payment causes a transition from the interim phase to the program phase. As mentioned above, in this phase the customer has demonstrated the ability to keep the account current and as a reward, the customer begins to receive cash-back rewards. Thus, upon reception of the forth payment, the account balance drops to $400 ($5 or 10% of the $50 payment is then added to the debit card as a cash-back reward). Similarly, upon reception of the 5^{th} payment, the balance is decreased to $350 ($5 or 10% of the $50 payment is again added to the debit as a cash-back reward). This process continues until the reception of the last payment. At this point the cash-back for the payment ($50) is combined with a cash-back reward for the first three payments ($15) and this is added to the balance of the debit card. As such, the current balance then becomes $0 with a total of $60 having been added onto the debit card as cash-back rewards.

TABLE 1

| Starting Balance: | Repayment Obligation: | Program Completion |
|---|---|---|
| $1100 | $600 | Reward: $500 |

| | |
|---|---|
| Payment $50/month | Cash-back Opportunity: $60 |

| Payment | Active Phase | Activity | Current Balance |
|---|---|---|---|
| 1 | Transition from | Prepaid Debit Card issued/active | ($550) |
| | establishment to | No cash rewards | |
| | interim phase | | |
| 2 | Maintain interim | Prepaid Debit Card active | ($500) |
| | phase | No cash rewards | |
| 3 | Maintain interim | Prepaid Debit Card active | ($450) |
| | phase | No cash rewards | |
| 4 | Transition to | Prepaid Debit Card active | ($400) |
| | program phase | 10% of payment ($5) goes to debit card | |
| 5 | Maintain program | Prepaid Debit Card active | ($350) |
| | phase | 10% of payment ($5) goes to debit card | |
| 6 | Maintain program | Prepaid Debit Card active | ($300) |
| | phase | 10% of payment ($5) goes to debit card | |
| 7 | Maintain program | Prepaid Debit Card active | ($250) |
| | phase | 10% of payment ($5) goes to debit card | |
| 8 | Maintain program | Prepaid Debit Card active | ($200) |
| | phase | 10% of payment ($5) goes to debit card | |
| 9 | Maintain program | Prepaid Debit Card active | ($150) |
| | phase | 10% of payment ($5) goes to debit card | |
| 10 | Maintain program | Prepaid Debit Card active | ($100) |
| | phase | 10% of payment ($5) goes to debit card | |
| 11 | Maintain program | Prepaid Debit Card active | ($50) |
| | phase | 10% of payment ($5) goes to debit card | |
| 12 | Maintain program | Prepaid Debit Card active, fees begin | $0 |
| | phase | 10% of payment and recapture 10% of | |
| | | payments 1-3 ($20)go to debit card | |

In a particular embodiment of the invention, the provider utilizes the services of a third party prepaid debit card company, such as NETSPEND, to provision the program. In this embodiment, as long as the customer makes the required payments, the program flows as outlined in Table 1. However, if the customer misses a payment (or a threshold number of payments), the fees associated with the prepaid debit card are no longer gratuitous to the customer (the provider stops paying them on behalf of the customer). The provider still tries to collect on the account, however, at this point the third party prepaid debit card company assumes the responsibility for billing the card fees to the customer.

In addition, as described above, during the first year of the program, the provider may pay all or some of the prepaid debit card fees for a period of time. After the expiration of this period of time (i.e. 1 year), the customer then has to pick up the ongoing fees for the prepaid debit card. Further, as the customer uses the card, the third party debit card provider then provides a percentage of the fees from the customer to the provider.

It will be appreciated that either the credit account or the prepaid debit card can be used to improve the debt recovery process. However, it will also be appreciated that a combination of the two methods, as well as combinations of the particular embodiments described could be implemented as a recovery program.

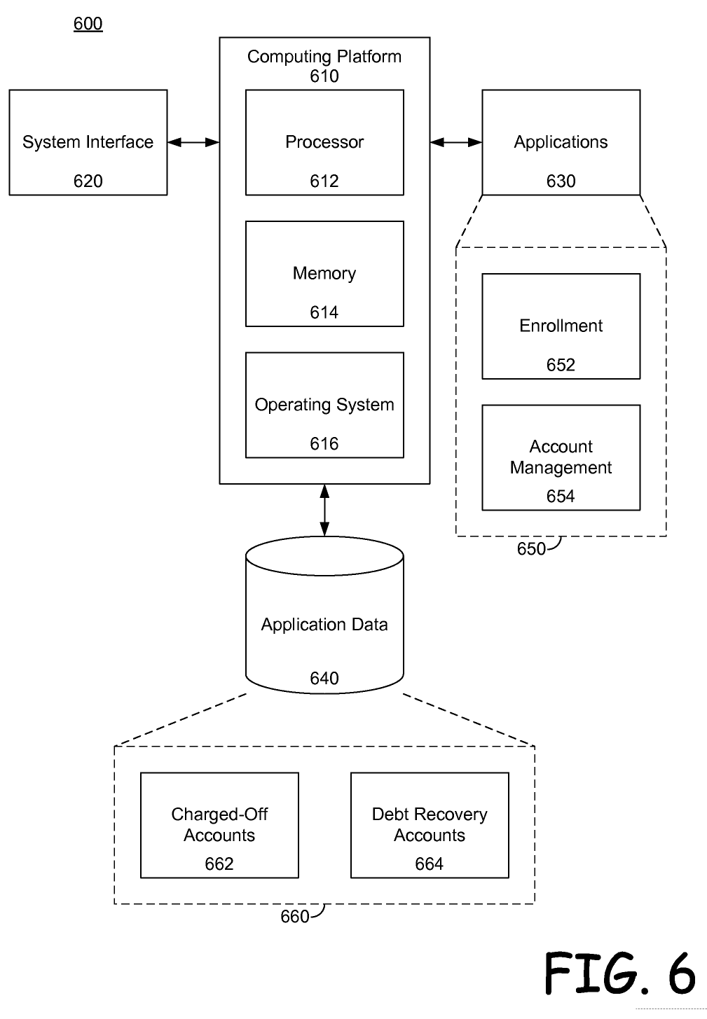

FIG. 6 shows a computer system 600 for administering debt recovery accounts. The computer system 600 includes a computing platform 610, a system interface module 620, an applications module 630, and an application data source 640. The computer system 600 supports one or more users for executing administrative processes related to the debt recovery accounts. The systems and methods described above with regard to FIGS. 1-4 may be implemented in whole or in part with a variety of computer systems. Computer systems for administering credit accounts are well-known and modification to implement the features described above is a matter of routine operation dependent on the particular platform, need for system integration, and the preferences of the implementer.

The computing platform 610 includes a processor 612, memory 614, and an operating system 616. The computing platform 610 instantiates and executes program instructions to provide data management, calculation, and communication functions. Common computing platforms for financial applications include personal computers (desktops, laptops, tablets, etc.), servers, clusters, and mainframes. Other computing platforms include personal digital assistants, cellular telephones, game systems, media systems, embedded systems, wearable computers, and special purpose computers (cash registers, ATMs, routers, medical systems, etc.). The computing platform 610 executes the instructions of one or more applications from the applications module 630 to operate on data from the application data source 640. Input, output, and other communications are provided through the system interface module 620.

The system interface module 620 provides means for interacting with the resources of the computing platform 610 and the applications and data processed thereby. The system interface module 620 includes input, output, communication, and combination devices and subsystems. Common system interface components include displays, keyboards, mice, speakers, network devices (modems, network cards, transceivers, etc.), and media drives (disc, CD-ROM, DVD-ROM, tape, card, flash memory, etc.). The network devices may integrate the computer system 600 into a larger network, such as a telephony-based network, proprietary network, local area network, intranet, wide area network, or the Internet. Networking may allow the resources of the computer system 600 to be distributed among a variety of geographically dispersed components, including multiple or distributed computing platforms. Other system interface components include printers, scanners, cameras, detectors, card readers, prototypers, game controllers, touch screens, and many others. Implementation of the system interface module 620 will depend upon the nature of the computer platform 610 and the circumstances and preferences of the user.

The applications module 630 includes any number of application programs supporting administration of debt recovery accounts. The applications module 630 includes credit account management applications 650. The credit account management applications 650 include a variety of administrative applications (some not shown), such as an enrollment module 652 and an account management module 654. The enrollment module 652 includes one or more applications to assist in the identification of candidate charged-off accounts, management of the solicitation of and negotiation with candidate customers, and establishment of new debt recovery accounts. In one embodiment, the enrollment module 652 implements computer assistance for the method 300 in FIG. 3. The account management module 654 includes one or more applications to assist in the management of active debt recovery accounts, including billing, payment handling, charge handling, and implementation of account terms (status, fees, interest, minimum payments, conditions, etc.). In one embodiment, the account management module 652 implements computer assistance for the method of claim 400 in FIG. 4.

The application data source 640 includes any number of data sources supporting administration of the data recovery accounts and the related applications in the applications module 630. The application data source 640 may include a variety of hardware storage devices, such as hard drives, removable media (disc, CD-ROM, DVD-ROM, tape, card, flash memory, etc.), or storage servers or networks. The application data source 640 may also include software systems, such as file systems, relational database management systems, or a variety of other data management platforms. The application data source 640 includes credit account management data 660, including charged-off account data 662 and debt recovery account data 664. The charged-off account data 662 includes records of customers with charged-off account balances. The debt recovery account data 664 includes records for customers with active debt recovery accounts. The records in the debt recovery account data 664 may include, among other data, account balance, credit limit, available credit, open-to-buy status, card issued status, over-limit status, and periodic bill information (suggested payment, open-to-buy payment, minimum payment, automatic payment, etc.).

As an example, a particular configuration of a system for implementing the present invention is provided. In various embodiments, the system may be implemented on a single personal computer or a system of networked machines and can be based on ORACLE/SQL and SAS. The general process involves creating a file by extracting information from the ORACLE database the running on the server by issuing various SQL commands. We then process the file using SAS on a UNIX box. The final file is shipped to a solicitation group that can run programs off the network. The account monitoring, which is the basis of determining when a credit card should be issued, is performed on the UNIX box with SAS. The collection of these accounts and the triggering of some of the movement from “qualified for the program” to “not qualified” is done on a network of machines using a program called B-frame.

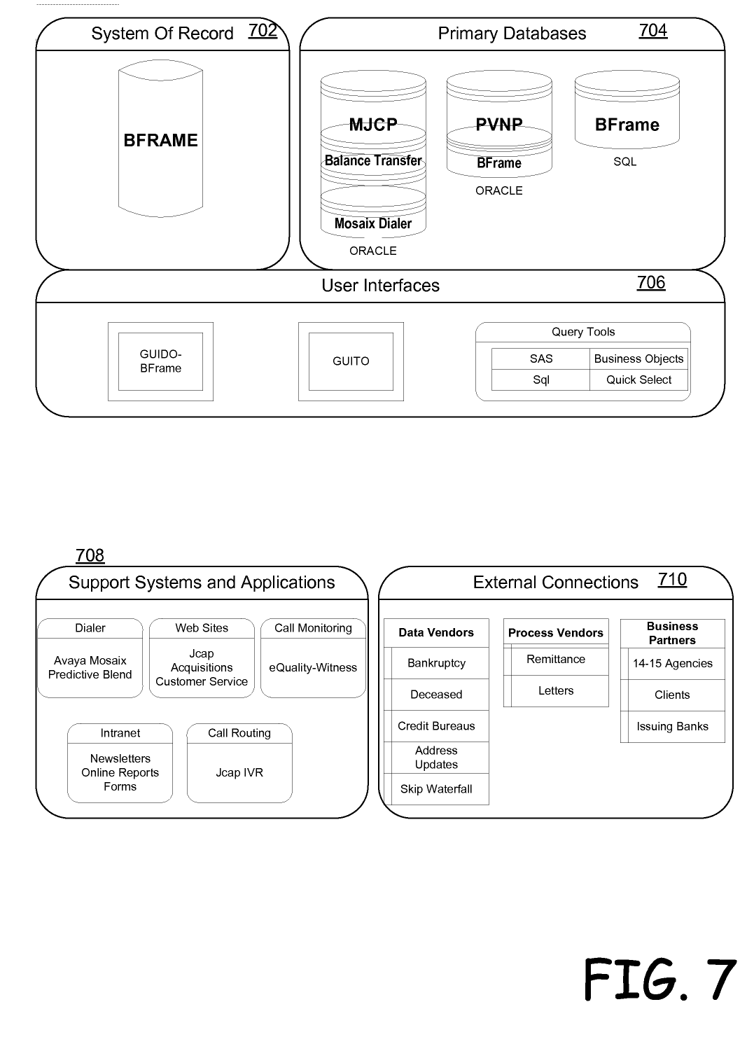

FIG. 7 is a system interaction diagram showing exemplary components of a potential system implementing an embodiment of the present invention. As is illustrated, the system include a system of record 702, primary databases 704, user interfaces 706, support systems and applications 708 and external connections 710. The diagram illustrates generally items and interfaces that will be known to those skilled in the art.

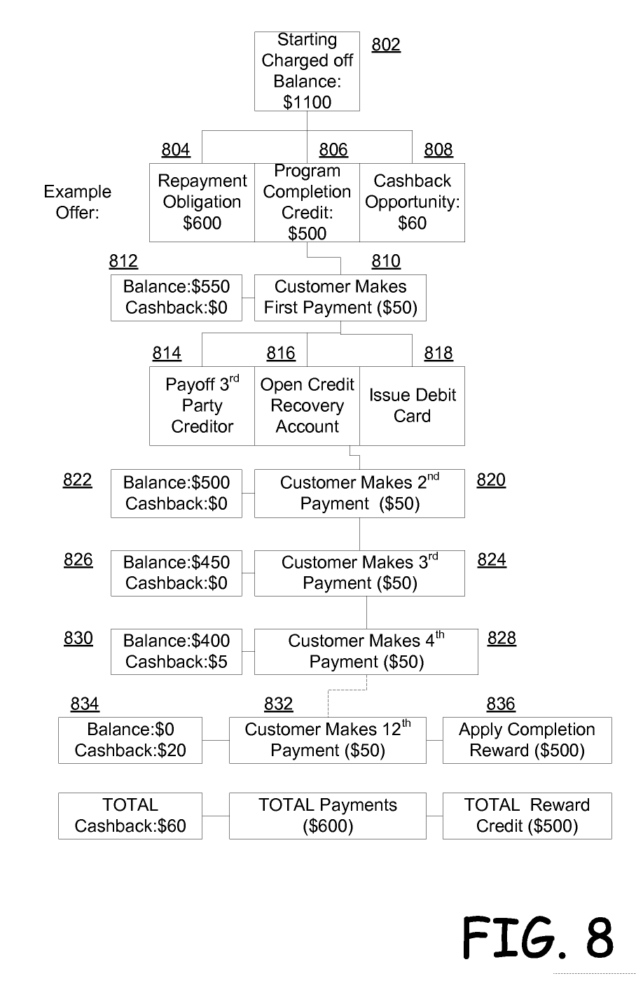

FIG. 8 is a flow diagram illustrating the operation of an embodiment of the present invention. The elements in FIG. 8 correspond with the example entries in Table 1. Basically, a starting balance of $1100 is inherited from the creditor 802. Of the $1100 starting balance, in the illustrated example, the customer's settlement repayment obligation 804 is set to $600, a program completion credit 806 makes up the balance of the $1100 and is $500, and the cash-back opportunity 808 for the customer is set at 10% of the settlement repayment obligation and equals $60. The payments are established over a 12 month period as $50 per month.

After the customer makes a first payment 810, the current balance then drops to $550 and the cash-back balance is at $0 812. In addition, at this point the third party creditor can be paid off 814, the credit recovery account is opened 816 and a debit card is issued 818.

Upon reception of the second payment 820, the account balance drops to $500 and the cash-back balance remains at $0 822. Upon reception of the third payment 824, the account balance drops to $450 and the cash-back balance remains at $0 826. The forth payment triggers the reception of the cash-back rewards. Thus, upon reception of the forth payment 828, the account balance drops to $400 ($5 or 10% of the $50 payment is then added to the debit card as a cash-back reward for a balance of $5) 830. Similarly, upon reception of the 5^{th} payment, the balance is decreased to $350 ($5 or 10% of the $50 payment is again added to the debit as a cash-back reward). This process continues until the reception of the last payment, or the 12^{th} payment. Upon reception of the 12^{th} payment, the account balance drops to $0 and the cash-back for the payment ($5) is combined with a cash-back reward for the first three payments ($15) and this is added to the balance of the debit card to bring the balance to $60 834. In addition, the $500 completion award is applied 836.

What is claimed is:

1. A method of recovering debt from a customer with a charge-off credit account balance, comprising:
establishing a payment program for selected term during which the account balance is to be paid off;
receiving a first timely payment from the customer, and in response, issuing and activating a prepaid debit card to the customer and adjusting the account balance in accordance with the payment;
receiving X additional timely payments from the customer, and in response to each such payment, maintaining the debit card active and adjusting the account balance in accordance with the payments; and
receiving timely payments beyond the X+1 payments, and in response to each such payment, maintaining the debit card active, adjusting the account balance in accordance with the payments and, activating a cash-back program for adjusting the account balance an additional percentage of the payment amount.

2. The method of claim 1, wherein the step of issuing and activating a prepaid debit card comprises using a third party vendor and further comprises the steps of:
subsidizing the fees associated with the prepaid debit card during the term.

3. The method of claim 2, further comprising the steps of:
establishing a purchase price for the charge-off credit account from the credit holder; and
and further in response to receiving the first timely payment, delivering the purchase price to the credit holder.

4. The method of claim 3, wherein if a timely payment is not received during the term, deactivating the prepaid debit card.

5. The method of claim 3, wherein if a timely payment of the first X+1 payments is not received, deactivating the prepaid debit card.

6. The method of claim 3, wherein if a timely payment is not received after having received the first X+1 payments, deactivating the cash-back program.

7. The method of claim 3, wherein if a timely payment is not received after having received the first X+1 payments, deactivating the cash-back program and the prepaid debit card.

8. The method of claim 3, further comprising the steps of:
if a timely payment of the first X+1 payments is not received, deactivating the prepaid debit card; and
if a timely payment is not received after having received the first X+1 payments, deactivating the cash-back program and the prepaid debit card.

9. The method of claim 8, wherein the term is 12 months and the value of X is 2, wherein the step of adjusting the account balance an additional percentage of the payment applies for the 4^{th} through the 12^{th} payments.

10. The method of claim 9, further comprising the steps of:
receiving a timely last payment, and in response to each such payment, maintaining the debit card active, adjusting the account balance in accordance with the payment and, adjusting the account balance an additional percentage of the payment amount in accordance with the cash-back program, and adjusting the account balance an additional percentage of the first 3 payments.

11. The method of claim 9, further comprising the step of ceasing to subsidize the fees associated with the prepaid debit card upon the reception of the final payment.

12. The method of claim 11, further comprising the step of receiving a percentage of the prepaid debit card fees from the third party vendor.

13. The method of claim 12, further comprising the steps of:
creating a recovery credit account for a customer with a charged-off credit account balance; and
set an opening balance of the recovery credit account to a value equal to at least a portion of the charged-off credit account balance and wherein the opening balance represents the entire debt obligation of the customer related to the charged-off credit balance.

14. The method of claim 13, further comprising issuing a credit token corresponding to the recovery credit account only after the recovery credit account balance is less than the credit limit, the credit token enabling access to an available balance of the recovery credit account.

15. The method of claim 14, further comprising charging an over limit fee when the recovery account balance is over the credit limit only after the recovery credit account balance has been less than the credit limit.

16. A method of recovering debt from a customer with a charge-off credit account balance, comprising:
establishing a purchase price for the charge-off credit account from the credit holder;
establishing a payment program for selected term during which the account balance is to be paid off,
receiving a first timely payment from the customer, and in response to such payment:
activating a prepaid debit card for the customer using a third party vendor;
subsidizing the fees associated with the prepaid debit card during the term; and
adjusting the account balance in accordance with the payment;
delivering the purchase price to the credit holder;
receiving X additional timely payments from the customer, and in response to each such payment, maintaining the debit card active and adjusting the account balance in accordance with the payments; and
receiving timely payments beyond the X+1 payments, and in response to each such payment, maintaining the debit card active, adjusting the account balance in accordance with the payments and, activating a cash-back program for adjusting the account balance an additional percentage of the payment amount.

17. The method of claim 16, further comprising the steps of:
if a timely payment of the first X+1 payments is not received, deactivating the prepaid debit card; and
if a timely payment is not received after having received the first X+1 payments, deactivating the cash-back program and the prepaid debit card.

18. The method of claim 16, wherein the step of establishing a purchase price for the charge-off credit account from the credit holder comprising negotiating an option price for the charge-off credit account and, the step of delivering the purchase price to the credit holder comprising exercising the option.

19. The method of claim 18, further comprising the steps of:
creating a recovery credit account for a customer with a charged-off credit account balance; and
set an opening balance of the recovery credit account to a value equal to at least a portion of the charged-off credit account balance and wherein the opening balance represents the entire debt obligation of the customer related to the charged-off credit balance.

20. A method of recovering debt from a customer with a charge-off credit account balance, comprising:
creating a recovery credit account for a customer with a charged-off credit account balance;
establishing a payment program for selected term during which the account balance is to be paid off, set an opening balance of the recovery credit account to a value equal to at least a portion of the charged-off credit account balance and wherein the opening balance represents the entire debt obligation of the customer related to the charged-off credit balance;
based on the reception of payments:
issuing and activating a prepaid debit card to the customer
adjusting the credit recovery account balance in accordance with the payment;
activating a cash-back program for adjusting the credit recovery account balance an additional percentage of the payment amount; and
issuing a credit token corresponding to the recovery credit account only after completing repayment obligations for the recovery credit account balance, the credit token enabling access to an available balance of the recovery credit account.
